(19) United States
(12) Patent Application Publication
(10) Pub. No.: US 2010/0291453 A1
(43) Pub. Date: Nov. 18, 2010

(54) FUEL CELL SEPARATOR WITH HEAT CONDUCTING MEMBER OR COOLING FLUID PASSAGES IN A PERIPHERAL REGION OF THE CELL

(75) Inventors: Yasushi Araki, Getemba-shi Shizuoka-ken (JP); Fumihiko Inui, Toyota-shi Aichi-Ken (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, AIchi-ken (JP)

(21) Appl. No.: 12/528,155

(22) PCT Filed: Mar. 13, 2008
(86) PCT No.: PCT/IB2008/000589

§ 371 Date: Aug. 21, 2009

(30) Foreign Application Priority Data
Mar. 14, 2007 (JP) 2007 064354

(51) Int. Cl. H01M 8/04

(52) U.S. Cl. 429/434

(57) ABSTRACT

A fuel cell (100) includes a power generation part (800), a separator (600) that is alternately stacked on the power generation part (800), and a heat conduction member (900). The separator (600) has a first region that overlaps the power generation part (800) in the stacking direction and a second region that overlaps a non-power generation part (700) in the stacking direction. The heat conduction member (900) is disposed to overlap at least the second region of the separator (600) in the stacking direction, and has a heat-conductivity higher than that of the separator (600).

### BACKGROUND OF THE INVENTION

1. Field of the Invention

The present invention relates to a fuel cell.

2. Description of the Related Art

Conventionally, in fuel cells such as, for example, polymer electrolyte fuel cells, reaction gases (e.g. fuel gas that contains hydrogen and oxidant gas that contains oxygen) are respectively supplied to two electrodes (anode and cathode), with an electrolyte membrane interposed between the electrodes, to cause electrochemical reaction. The electrochemical reaction directly converts chemical energy to electrical energy to generate electricity. Such fuel cells have a so-called stack structure where separators and power generation parts including a generally plate-like electrolyte membrane are alternately stacked and fastened in the stacking direction.

Because the electrochemical reaction in the fuel cell produces heat, it is important to manage the temperature during operation of the fuel cell. For example, Japanese Patent Application Publication No. 2006-134698 (JP-A-2006-134698) describes a technique for forming a separator from two members with different heat conductivities. In addition, the separator has a groove-like reaction gas flow path in a region (power generation region) that overlaps the power generation part in the stacking direction. hi the technique described in JP-A-2006-134698, the part of the separator that forms the reaction gas flow path is made of a member having a lower heat conductivity, such as an insulating member, to increase the temperature in the reaction gas flow path. As a result, condensation of water in the reaction gas flow path is reduced. Japanese Patent Application Publication No. 7-282836 (JP-A-7-282836) and Japanese Patent Application Publication No. 2003-132911 (JP-A-2003-132911) also describe techniques for managing the temperature of a fuel cell.

The described techniques, however, do not take into account the difference in the temperature between the part of the separator that overlaps the power generation part in the stacking direction and the other part of the separator. Therefore, such a difference in the temperature may occasionally cause problems such as degradation of the power generation performance.

### SUMMARY OF THE INVENTION

The present invention provides a fuel cell in which the difference in the temperature is reduced between a region of the fuel cell where a power generation part is overlapped in the stacking direction and the other region of the fuel cell.

A first aspect of the present invention provides a fuel cell including: a power generation part that includes an electrolyte membrane; a non-power generation part that is disposed along an outer peripheral edge of the power generation part; a separator that is alternately stacked with the power generation part, and is provided with a gas flow path, through which a reaction gas flows to the power generation part, the separator having a first region that overlaps the power generation part in the stacking direction and a second region that overlaps the non-power generation part in the stacking direction; and a heat conduction member that overlaps at least the second region of the separator in the stacking direction and that has a heat conductivity higher than that of the separator.

According to the fuel cell of the first aspect, the heat conduction member is disposed to overlap in the stacking direction the second region, which overlaps the non-power generation part in the stacking direction. Consequently, the heat of the power generation part is easily conducted to the second region via the heat conduction member. Thus, the difference in the temperature may be reduced between the first region, which overlaps the power generation part in the stacking direction, and the second region is reduced. As a result, problems due to such a difference in the temperature are reduced.

The reaction gas may include oxidant gas and fuel gas. The separator may be provided with a first separator through which the oxidant gas flows and a second separator through which the fuel gas flows. The heat conduction member may be disposed between the first separator and the second separator, which in turn are disposed adjacent to each other with interposing the power generation part between the first separator and the second separator.

The heat conduction member may be disposed inside the separator.

In addition, the heat conduction member may be fitted in a recess that is formed in the separator.

A portion Of the heat conduction member may overlap the rust region of the separator in the stacking direction.

The separator may have a manifold hole in the second region through which the reaction gas flows, and the heat conduction member may be disposed around the manifold hole.

The separator may have a cooling medium flow path through which a cooling medium for cooling the power generation part flows; and the heat conduction member may overlap the cooling medium flow path in the stacking direction. In such a case, the cooling medium flow path may pass through the second region.

The heat conduction member may be in contact with the separator.

The manifold hole may include a supply manifold hole for supplying the reaction gas and a discharge manifold bole for discharging the reaction gas. Furthermore, the heat conduction member may be disposed around the discharge manifold hole.

The heat conduction member may be disposed around the supply manifold hole.

The heat conduction member may be disposed around the discharge manifold hole except for the first region side of the discharge manifold hole.

The discharge manifold hole may be positioned opposite to the direction of gravity with respect to the first region when the fuel cell is in operation.

In the fuel cell in accordance with the first aspect, the discharge manifold hole may be shaped so that water present in the discharge manifold hole collects at a portion of the discharge manifold hole due to gravity; and the heat conduction member may be disposed along the portion of the discharge manifold hole where the water collects.

The separator may include an anode plate, a cathode plate, and an intermediate plate disposed between the anode plate and the cathode plate; and the heat conduction member may be disposed in the intermediate plate.

The heat conduction member may contain copper.

The heat conduction member may have a heat conductivity of about 0.95 Cal·cm⁻¹·° C.⁻¹·second⁻¹.

A second aspect of the present invention provides a fuel cell including: a power generation part that includes an electrolyte membrane; a non-power generation part that is disposed along an outer peripheral edge of the power generation part; and a separator that is alternately stacked with the power generation part, and is provided with a cooling medium flow path through which a cooling medium for cooling the power generation part flows, the separator having a first region that overlaps the power generation part in the stacking direction and a second region that overlaps the non-power generation part in the stacking direction. The cooling medium flow path passes through the first region and the second region.

According to the fuel cell of the second aspect, the cooling medium may be used to cool the first region and warm the second region. Thus, the difference in the temperature between the first region, which overlaps the power generation part in the stacking direction, and the second region is reduced. As a result, problems due to such a difference in the temperature are reduced.

The separator may have a manifold hole that is formed to penetrate the second region in the stacking direction and through which a reaction gas flows. The cooling medium flow path may be disposed opposite to the first region with respect to the manifold hole.

The separator may have a plurality of manifold holes; and a portion of the cooling medium flow path may pass between the plurality of manifold holes.

The cooling medium flow path may include a first flow path that passes through the first region and a second flow path that passes through the second region; and the flow of the cooling medium in the first flow path and in the second flow path may be independently controlled based on operating conditions.

The fuel cell in accordance with the second aspect may further include: a heat conduction member that overlaps the second region of the separator in the stacking direction and that has a heat conductivity higher than that of the separator. Furthermore, the heat conduction member may be disposed in the separator to overlap the second flow path of the cooling medium flow path.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a first diagram showing the overall configuration of a fuel cell in accordance with an embodiment;

FIG. 2 is a second diagram showing the overall configuration of the fuel cell in accordance with the embodiment;

FIG. 3 is a first diagram showing the configuration of a membrane electrode assembly in accordance with the embodiment;

FIG. 4 is a second diagram showing the configuration of the membrane electrode assembly in accordance with the embodiment;

FIG. 5 is a first diagram showing the configuration of a separator in accordance with the embodiment;

FIG. 6 is a second diagram showing the configuration of the separator in accordance with the embodiment;

FIG. 7 is a first explanatory diagram illustrating the operation of the fuel cell;

FIG. 8 is a second explanatory diagram illustrating the operation of the fuel cell;

FIG. 9 is a diagram showing a membrane electrode assembly in accordance with a first modification;

FIG. 10 is a diagram showing a membrane electrode assembly in accordance with a second modification;

FIG. 11 is a diagram showing a separator in accordance with a third modification;

FIG. 12 is a diagram showing a separator in accordance with a fourth modification;

FIG. 13 is a diagram showing the schematic configuration of a fuel cell system including a fuel cell in accordance with the fourth modification;

FIG. 14 is a diagram showing a separator in accordance with a fifth modification;

FIG. 15 is a diagram showing a separator in accordance with a sixth modification; and

FIG. 16 is a diagram showing respective plates composing a separator in accordance with a seventh modification.

### DETAILED DESCRIPTION OF EMBODIMENTS

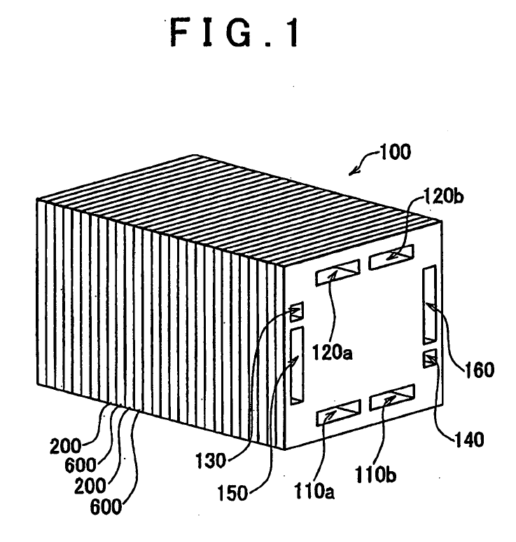

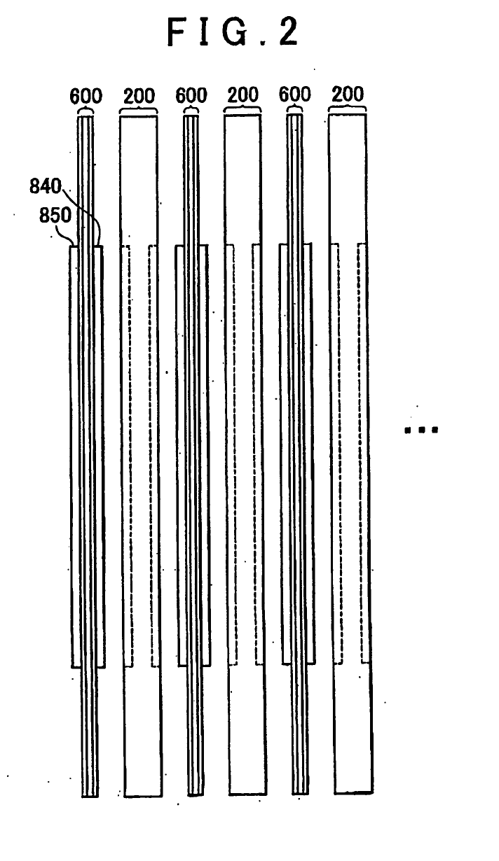

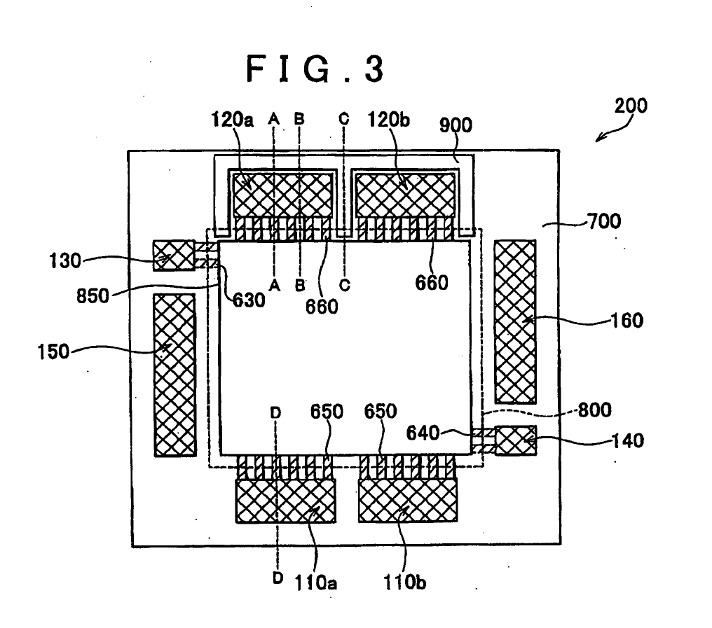

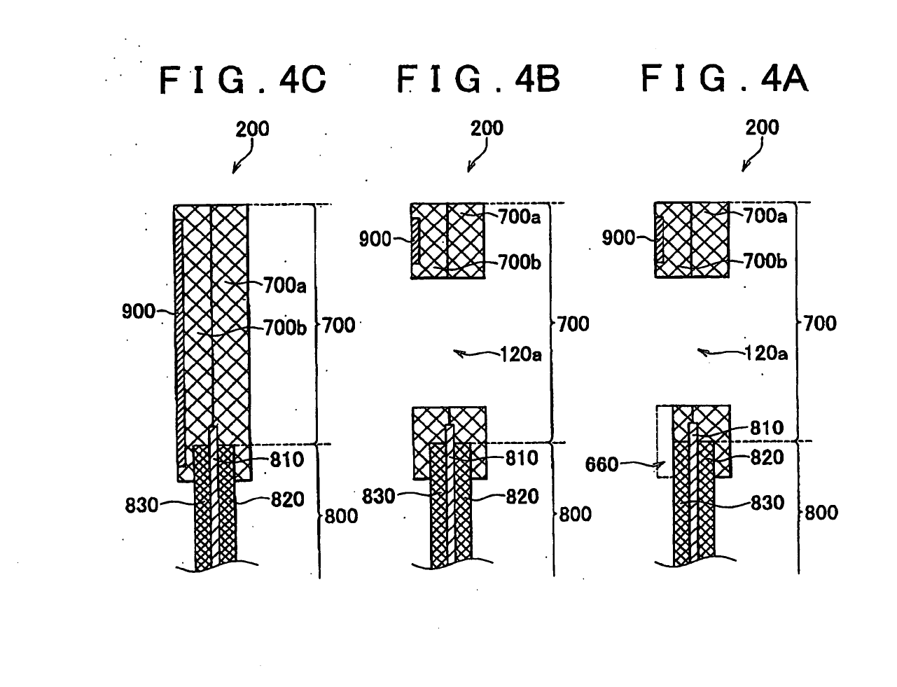

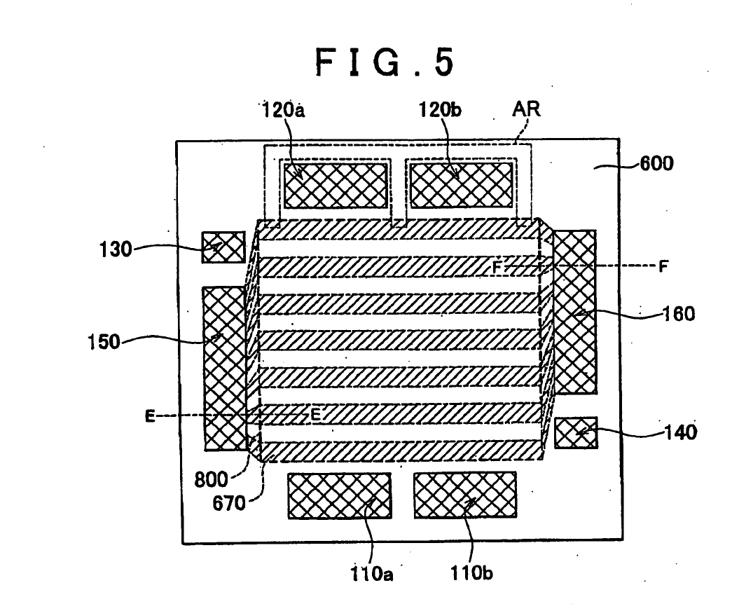

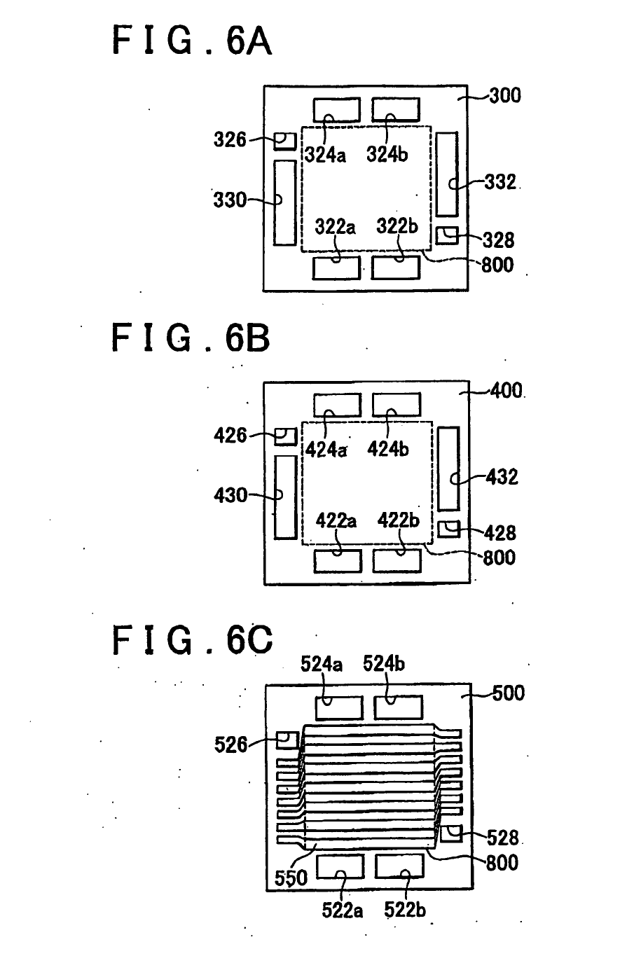

The configuration of the fuel cell in accordance with the embodiment of the present invention is described with reference to FIGS. 1 to 6. FIGS. 1 and 2 show the overall configuration of the fuel cell in accordance with the embodiment. FIGS. 3 and 4 show a membrane electrode assembly in accordance with the embodiment. FIG. 3 is a plan view of the membrane electrode assembly. FIGS. 4A to 4C are cross sectional views take along the lines A-A, B-B, and C-C, respectively, of FIG. 3. FIG. 5 is a plan view of a separator. FIG. 6 shows plan views of respective plates composing the separator.

As shown in FIG. 1, a fuel cell 100 has a stack structure in which a plurality of membrane electrode assemblies 200 and separators 600 are stacked alternately. As shown in FIG. 2, either an anode-side porous body 840 or a cathode-side porous body 850 may be disposed between the separator 600 and the membrane electrode assembly 200. The anode-side porous body 840 may be provided integrally with the separator 600 as in the example shown in FIG. 2, or may be provided separately from the separator 600.

The anode-side porous body 840 is disposed between the anode side of the Separator 600 and the anode side of the membrane electrode assembly 200. The cathode-side porous body 850 is disposed between the cathode side of the separator 600 and the cathode side of the membrane electrode assembly 200. The anode-side porous body 840 and the cathode-side porous body 850 are made of a porous material having gas diffusivity and electrical conductivity, such as a porous metallic material. The anode-side porous body 840 and the cathode-side porous body 850 has a higher porosity and a lower flow resistance than those of an anode-side diffusion layer 820 and a cathode-side diffusion layer 830 to be described later, so that they serve as a flow path for reaction gases.

As shown in FIG. 1, the fuel cell 100 is provided with oxidant gas supply manifolds 110a and 110b, oxidant gas discharge manifolds 120a and 120b, a fuel gas supply manifold 130, a fuel gas discharge manifold 140, a cooling medium supply manifold 150, and a cooling medium discharge manifold 160. Air is typically used as the oxidant gas. Hydrogen is typically used as the fuel gas. The oxidant gas and the fuel gas may both be referred to as “reaction gas.” Water, antifreeze such as ethylene glycol, air, etc., may be used as the cooling medium.

The configuration of the membrane electrode assembly 200 is described while referring to FIGS. 3 and 4. As shown in FIGS. 3 and 4, the membrane electrode assembly 200 is made up of a power generation part 800 and a non-power generation part 700.

As shown in FIG. 4, the power generation part 800 is made up of a power generation unit 810, an anode-side diffusion layer 820, and a cathode-side diffusion layer 830 stacked together.

In this embodiment, the power generation unit 810 is an ion exchange membrane with one surface coated with a cathode-catalyst layer and with the other surface coated with an anode-catalyst layer (the catalyst layers are not shown). The ion exchange membrane is made of a fluorine resin material or a hydrocarbon resin material, and has a good ion conductivity when wet. The catalyst layers may contain platinum or an alloy of platinum and another metal, for example.

The anode-side diffusion layer 820 is disposed in contact with the anode-side surface of the power generation unit 810. The cathode-side diffusion layer 830 is disposed in contact with the cathode-side surface of the power generation unit 810. The anode-side diffusion layer 820 and the cathode-side diffusion layer 830 are made of carbon cloth woven from carbon fiber thread, carbon paper, or carbon felt, for example.

In FIG. 3, the outer peripheral ends of the cathode-side diffusion layer 830 and the anode-side diffusion layer 820 are indicated by the dashed line. The part inside the dashed line corresponds to the power generation part 800.

The non-power generation part 700 is disposed around the entire outer periphery of the power generation part 800. The non-power generation part 700 is made up of two seal members air-tightly bonded together, namely a first member 700a and a second member 700b. The outer peripheral ends of the power generation unit 810, the cathode-side diffusion layer 830, and the anode-side diffusion layer 820 are held between the first member 700a and the second member 700b. This reduces mixing of the reaction gases between the anode side and the cathode side of the power generation unit 810. The first member 700a and the second member 700b are made of a material having insulating properties, gas impermeability, and heat resistance in the operating temperature range of the fuel cell, for example resin materials such as a thermosetting resin and a multi-purpose plastic.

As indicated by the cross-hatched areas in FIG. 3, the non-power generation part 700 is formed with through holes (manifold holes) corresponding to the respective manifolds 110a to 160 shown in FIG. 1. The non-power generation part 700 is air-tightly bonded to adjacent separators 600 (not shown) on both sides to seal the gap between the non-power generation part 700 and the separators 600. This prevents leakage of the reaction gases (in this embodiment, hydrogen and air) and the coolant. Specifically, the entire periphery of the power generation part 800 and the entire peripheries of the respective manifold holes (except for flow paths for supplying/discharging the reaction gas to be described later) are sealed.

Fuel gas supply flow paths 630, fuel gas discharge flow paths 640, oxidant gas supply flow paths 650, and oxidant gas discharge flow paths 660 for supplying/discharging the reaction gas are formed in the non-power generation part 700. As indicated by the single-hatched areas in FIG. 3, the flow paths 630 to 660 are formed as grooves, and do not penetrate the non-power generation part 700. The fuel-gas supply flow paths 630 and the fuel-gas discharge flow paths 640 are formed in the back side of FIG. 3, or the anode side of the non-power generation part 700. The oxidant gas supply flow paths 650 and the oxidant gas discharge flow paths 660 are formed in the front side of FIG. 3, or the cathode side of the non-power generation part 700. The fuel-gas supply flow paths 630 communicate between the fuel-gas supply manifold 130 and the anode-side porous body 840. The fuel-gas discharge flow paths 640 communicate between the fuel-gas discharge manifold 140 and the anode-side porous body 840. The oxidant gas supply flow paths 650 communicate between the oxidant gas supply manifolds 110a and 110b and the cathode-side porous body 850. The oxidant gas discharge flow paths 660 communicate between the oxidant gas discharge manifolds 120a and 120b and the cathode-side porous body 850.

As shown in FIG. 3, a heat conduction member 900 is disposed on the cathode side of the non-power generation part 700 (the front side of FIG. 3), that is, the side of the non-power generation part 700 that is bonded to the surface of a cathode plate 400 of the separator 600, to be described later. The heat conduction member 900 is disposed along three sides of the rectangular through holes forming the oxidant gas discharge manifolds 120a and 120b. Specifically, the heat conduction member 900 is formed in the shape of the letter “E,” and disposed around the rectangular through holes except for the part communicated with the oxidant gas discharge flow paths 660. As shown in FIG. 3, one end portion of the heat conduction member 900 overlap the power generation part 800 (the part corresponding to the anode-side diffusion layer 820 and the cathode-side diffusion layer 830) of the membrane electrode assembly 200 in the stacking direction of the fuel cell 100. Meanwhile, the remainder of the heat conduction member 900 is located on the outer side, and does not overlap the power generation part 800. The heat conduction member 900 is fitted in a recess formed in the second member 700b and has a shape and a depth corresponding to the shape and the thickness of the heat conduction member 900.

The heat conduction member 900 is made of a material that has a heat conductivity greater than that of the separator 600, which will be described later. In this embodiment, the heat conduction member 900 is made of copper (having a heat conductivity of about 0.95 Cal·cm⁻¹·° C.⁻¹·second⁻¹).

Next, the configuration of the separator 600 will be described with reference to FIGS. 5 and 6. The separator 600 is made up of an anode plate 300, a cathode plate 400, and an intermediate plate 500.

FIGS. 6A to 6C are explanatory diagrams showing the shape of the anode plate 300 (FIG. 6A), the cathode plate 400 (FIG. 6B), and the intermediate plate 500 (FIG. 6C), respectively, in accordance with the embodiment. The region indicated by the broken line in the center of the respective plates 300, 400, and 500, and the separator 600 overlap the power generation part 800 in the stacking direction.

The respective plates 300, 400, and 500 are made of a material less expensive and having a lower heat conduction than that of the heat conduction member 900 described above. In this embodiment, the respective plates 300, 400, and 500 are made of stainless steel, which has a heat conductivity of about 0.15 to 0.20 Cal·cm⁻¹·° C.⁻¹·second⁻¹.

The anode plate 300 and the cathode plate 400 are formed with manifold forming parts penetrating the plate in the thickness direction and corresponding to the respective manifolds in FIG. 1. That is, the anode plate 300 is formed with manifold forming parts 322a, 322b, 324a, 324b, 330, 332, 326, and 328, and the cathode plate 400 is formed with manifold forming parts 422a, 422b, 424a, 424b, 430, 432, 426, and 428.

The intermediate plate 500 is formed with manifold forming parts 522a, 522b, 524a, 524b, 526, and 528 penetrating the intermediate plate 500 in the thickness direction and corresponding to the manifolds for supplying/discharging the reaction gas (oxidant gas or fuel gas) shown in FIG. 1. The intermediate plate 500 is further formed with a plurality of cooling medium flow path forming parts 550.

Each cooling medium flow path forming part 550 is shaped in an elongated hole extending across the power generation part 800 in the left and right direction of FIG. 6C, with its both ends located on the outer side of the power generation part 800. The cooling medium flow path forming part 550 may be formed over the entire power generation part 800.

FIG. 5 is a front view of the separator 600 fabricated using the respective plates 300, 400, and 500. The separator 600 is fabricated by joining the anode plate 300 and the cathode plate 400 to both sides of the intermediate plate 500 so that the intermediate plate 500 is held between the anode plate 300 and the cathode plate 400, and punching the part of the intermediate plate 500 exposed to the regions corresponding to the cooling medium supply manifold 150 and the cooling medium discharge manifold 160. The three plates may be joined together, for example, by thermocompression bonding, brazing, welding, etc. As a result, a separator 600 can be obtained including through parts for forming the respective manifolds shown in mo. 1 when the fuel cell 100 is formed, and a plurality of cooling medium flow paths 670, as indicated by the hatched areas in FIG. 5. The cooling medium flow paths 670 pass inside the separator 600, with one end communicated with the cooling medium supply manifold 150 and with the other end communicated with the cooling medium discharge manifold 160.

The heat conduction member 900 contacts the cathode-side surface of the separator 600. The dashed line in FIG. 5 indicates the region AR on the separator 600 that contacts the heat conduction member 900 when the fuel cell 100 is formed. In the fuel cell 100, the heat conduction member 900 is interposed between the second member 700b and the cathode plate 400, and the second member 700b and the cathode plate 400 contact each other. A major part of the heat conduction member 900 is disposed in the region not overlapping the power generation part 800 as viewed in the stacking direction of the fuel cell 100, or the region on the outer side of the power generation part 800 in this embodiment. Specifically, as shown in FIGS. 3 and 5, the heat conduction member 900 is disposed along the periphery of the oxidant gas discharge manifolds 120a and 120b, which penetrate the fuel cell 100 in the stacking direction, except for the part where the oxidant gas discharge flow paths 660 are formed. The ends of the letter “E” shape of the heat conduction member 900 overlap the power generation part 800, and a cooling medium flow path 670 formed inside the separator 600, as viewed in the stacking direction of the fuel cell 100.

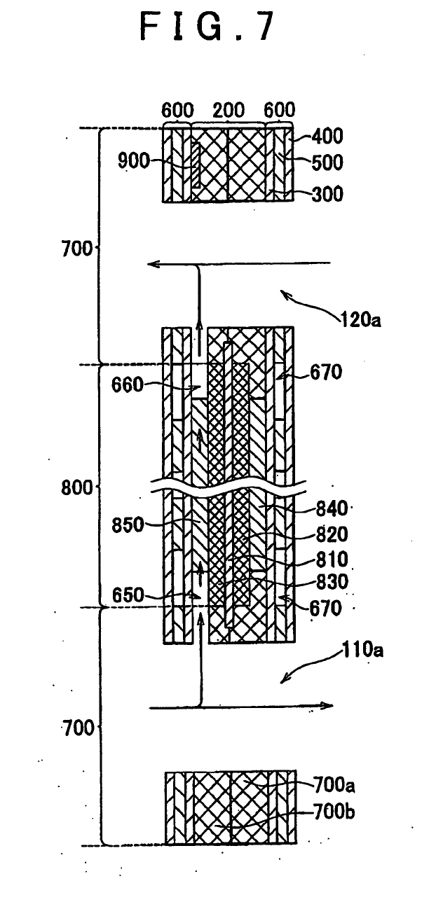

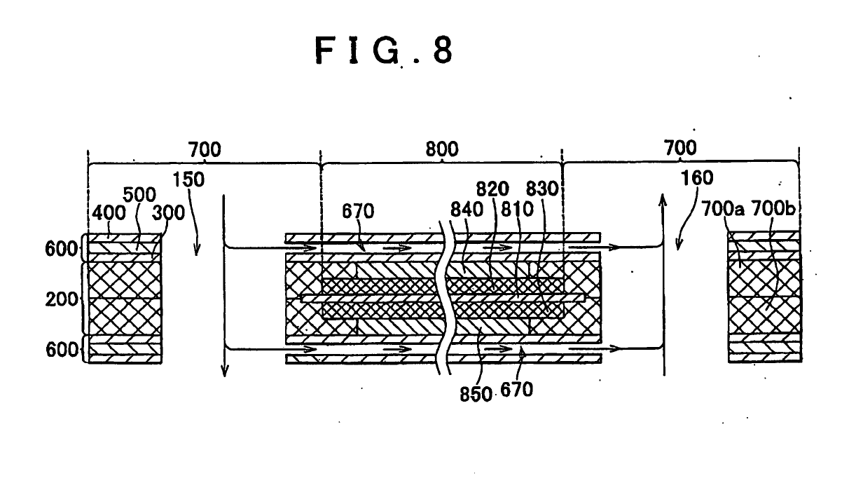

The operation of the fuel cell 100 in accordance with the embodiment is described with reference to FIGS. 7 and 8. FIG. 7 shows the flow of the oxidant gas. FIG. 8 shows the flow of the cooling medium. For ease of viewing, only one membrane electrode assembly 200 and separators 600 disposed on both sides of that membrane electrode assembly 200 are shown in FIGS. 7 and 8. The upper half of FIG. 7 is a cross sectional view taken along the line A-A of FIG. 3. The lower half of FIG. 7 is a cross sectional view taken along the line D-D of FIG. 3. The left half of FIG. 8 is a cross sectional view taken along the line E-E of FIG. 5. The right half of FIG. 8 is a cross sectional view taken along the line F-F of FIG. 5.

The fuel cell 100 generates electricity when oxidant gas is supplied to the oxidant gas supply manifolds 110a and 110b and fuel gas is supplied to the fuel gas supply manifold 130. While the fuel cell 100 is generating electricity, a cooling medium is supplied to the cooling medium supply manifold 150 to suppress an increase in the temperature of the fuel cell 100 due to heat produced along with the power generation.

As indicated by the arrows in FIG. 7, the oxidant gas supplied to the oxidant gas supply manifold 110a or 110b passes through the oxidant gas supply flow path 650 to be supplied to the cathode-side porous body 850. The oxidant gas supplied to the cathode-side porous body 850 flows inside the cathode-side porous body 850, which functions as the flow path of the oxidant gas, from the lower side to the upper side of FIG. 7. Then, the oxidant gas flows from the cathode-side porous body 850 into the oxidant gas discharge flow path 660, through which it is discharged to the oxidant gas discharge manifold 120a or 120b. Some of the oxidant gas flowing in the cathode-side porous body 850 diffuses over the entire cathode-side diffusion layer 830 contacting the cathode-side porous body 850, and is used in the cathode reaction (for example, 2H⁺+2e⁻+(1/2)O₂→H₂O).

Although the corresponding cross sectional view is not shown, the fuel gas supplied to the fuel gas supply manifold 130 passes through the fuel gas supply flow path 630 to be supplied to the anode-side porous body 840, in the same manner as the oxidant gas. The fuel gas supplied to the anode-side porous body 840 flows inside the anode-side porous body 840, which functions as the flow path of the fuel gas. Then, the fuel gas flows from the anode-side porous body 840 into the fuel gas discharge flow path 640, through which the fuel gas is discharged to the fuel gas discharge manifold 140. Part of the fuel gas flowing in the anode-side porous body 840 diffuses over the entire anode-side diffusion layer 820 that is in contact with the anode-side porous body 840, and may be used in the anode reaction (for example, H₂→2H⁺+2e⁻).

As shown in FIG. 8, the cooling medium supplied to the cooling medium supply manifold 150 is supplied via the cooling medium flow path 670. The cooling medium supplied to the cooling medium flow path 670 flows through the cooling medium flow path 670 to the cooling medium discharge manifold 160. The cooling medium cools the power generation part 800 by absorbing heat from the power generation part 800 of the membrane electrode assembly 200 as it flows by the power generation part 800.

According to the embodiment described above, the difference in the temperature in the fuel cell between the portion that overlaps overlapping the power generation part in the stacking direction and the part inside and around the oxidant gas discharge manifolds 120a and 120b may be reduced. This is because disposing the heat conduction member 900 at the above-described position facilitates conduction of reaction heat produced in the power generation part to the vicinity of the oxidant gas discharge manifolds 120a and 120b. This reduces condensation of water contained in the oxidant gas (such as generated water) when the oxidant gas is rapidly cooled in the oxidant gas discharge manifolds 120a and 120b. The condensed water hinders the smooth flow of the oxidant gas, and therefore degrades the power generation performance. If the difference in the temperature is increased between the part overlapping the power generation part in the stacking direction and the vicinity of the oxidant gas discharge manifolds 120a and 120b, the separator 600 and the non-power generation part 700 may be subjected to thermal strain to deteriorate the sealability between the separator 600 and the non-power generation part 700. In this embodiment, such thermal strain may be reduced to improve the sealability.

If the temperature of air outside the fuel cell is low (for example, below freezing), the difference in temperature between the part overlapping the power generation part in the stacking direction and the part inside the oxidant gas discharge manifolds 120a and 120b tends to be large. Therefore, it is more effective to dispose the heat conduction member 900 as described above. With the demand for reducing the size of the fuel cell 100, it is desired to reduce the thickness of the separator 600. The reducing the thickness of the separator 600 with a reduced thickness, however, also reduces the heat conduction of the separator 600. Therefore, it is more effective to dispose the heat conduction member 900 as the separator 600 is thinner, where the temperature difference between the part overlapping the power generation part in the stacking direction and the part inside the oxidant gas discharge manifolds 120a and 120b tends to be greater.

It is even more effective to dispose the heat conduction member 900 when the fuel cell 100 is operated with the oxidant gas discharge manifolds 120a and 120b positioned opposite to the direction of gravity and the oxidant gas supply manifolds 110a and 110b positioned in the direction of gravity. More specifically, in such a state, the oxidant gas flows in the membrane electrode assembly 200 in the direction opposite to that of gravity, from the oxidant gas supply manifolds 110a and 110b positioned below to the oxidant gas discharge manifolds 120a and 120b positioned above. Thus, water that condenses somewhere in the oxidant gas discharge flow path 660 in the vicinity of the oxidant gas discharge manifolds 120a and 120b cannot be expected to be discharged due to gravity. In addition, water that condenses in the oxidant gas discharge manifolds 120a and 120b tends to accumulate in a portion of the oxidant gas discharge manifolds 120a and 120b communicated with the oxidant gas discharge flow path 660 due to gravity. Thus, when operating in such a state, water condensation in the oxidant gas discharge flow path 660 and the oxidant gas discharge manifolds 120a and 120b tends to hinder the flow of the oxidant gas, which may lead to a more significant problem in the power generation performance. In this embodiment, by disposing the heat conduction member 900, it is possible to suppress a decrease in the temperature in the vicinity of the oxidant gas discharge manifolds 120a and 120b, and thus to effectively reduce condensation in the oxidant gas discharge flow path 660.

In addition, in this embodiment, the heat conduction member 900 is disposed such that on end portion of the heat conduction member 900 overlap the power generation part. Therefore, the heat of the power generation part is easily conducted via the heat conduction member 900 to the manifolds 120a and 120b. As a result, the difference in the temperature between the part overlapping the power generation part in the stacking direction and the part inside and around the oxidant gas discharge manifolds 120a and 120b is further effectively reduced.

Although the heat conduction member 900 is disposed only around the oxidant gas discharge manifolds 120a and 120b in the embodiment described above, an additional heat conduction member may be disposed around other manifolds. Examples in which an additional heat conduction member is disposed around other manifolds are described as a first modification and a second modification.

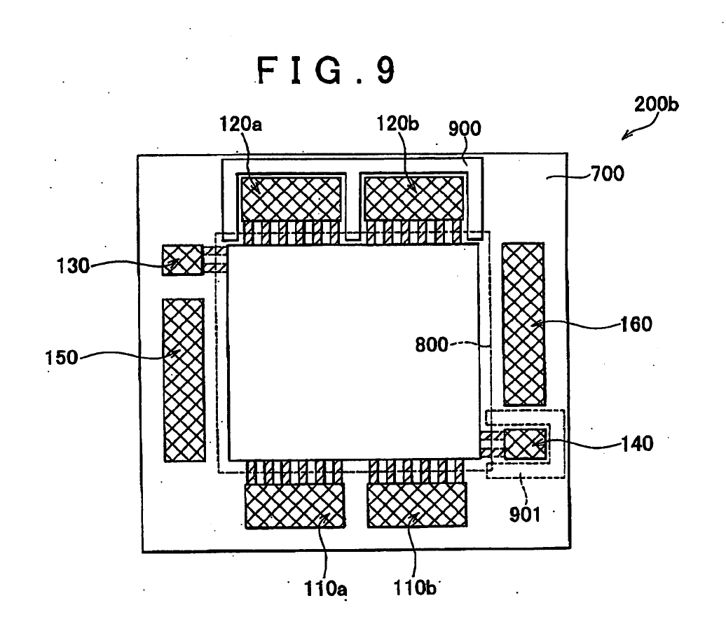

The first modification is described with reference to FIG. 9. FIG. 9 shows a membrane electrode assembly in accordance with the fiat modification.

A membrane electrode assembly 200b in accordance with the first modification, differs from the above embodiment in that a second heat conduction member 901 is disposed around the fuel gas discharge manifold 140 (FIG. 9). The heat conduction member 901 is made of the same material as that of the heat conduction member 900. The heat conduction member 901 is disposed in the first member 700a of the membrane electrode assembly 200 (the back side of FIG. 9). Thus, in the fuel cell using the membrane electrode assembly 200b in accordance with the first modification, the heat conduction member 901 contacts both the first member 700a side of the membrane electrode assembly 200b and the anode plate 300.

The configuration of the rest of the fuel cell in accordance with the first modification is the same as that of the fuel cell 100 in accordance with the above embodiment, and therefore is not described here.

According to the first modification, the following functions and effects can be obtained, in addition to those obtained by the embodiment described above. The difference in the temperature between the part overlapping the power generation part in the stacking direction and the part inside and around the fuel gas discharge manifold 140 is reduced. As a result, problems due to such a difference in the temperature are reduced, such as condensation in the fuel gas discharge manifold 140 and deterioration of the scalability around the fuel gas discharge manifold 140.

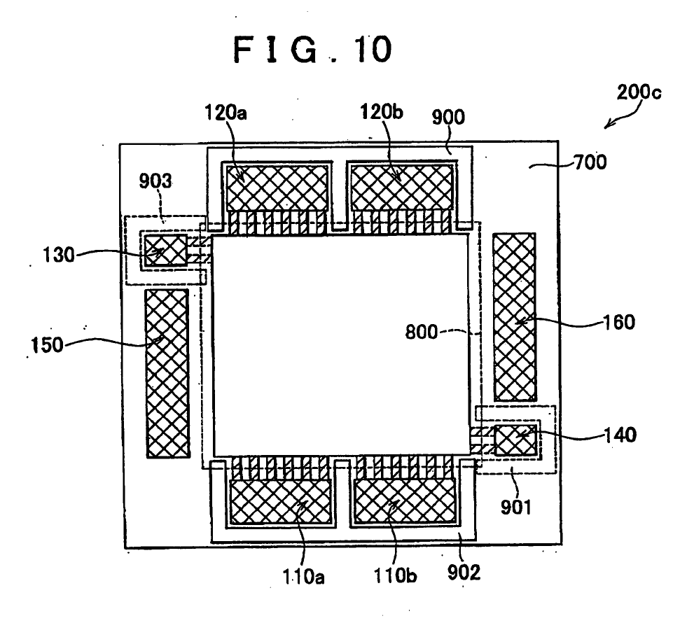

The second modification is described with reference to FIG. 10. FIG. 10 shows a membrane electrode assembly in accordance with the second modification.

A membrane electrode assembly 200c in accordance with the second modification further includes additional heat conduction members 902 and 903, in addition to the heat conduction members 900 and 901 disposed in the same way as in the first modification. The heat conduction members 902 and 903 are made of the same material as that of the heat conduction member 900, for example. The heat conduction member 902 is disposed around the fuel gas supply manifolds 110a and 110b, and the heat conduction member 903 is disposed around the fuel gas supply manifold 130 (FIG. 10).

The configuration of the rest of the fuel cell in accordance with the second modification is the same as that of the fuel cell 100 in accordance with the above embodiment, and therefore is not described here.

According to the second modification, the following functions and effects are obtained, in addition to those obtained by the first modification described above. The difference in the temperature between the part overlapping the power generation part in the stacking direction and the part inside and around the reaction gas supply manifolds 110a, 110b, and 130 is reduced. As a result, problems due to such a difference in the temperature are reduced, such as deterioration of the sealability around the supply manifolds 110a, 110b, and 130.

The difference in the temperature described above may be more effectively reduced using a separator with an elaborately designed cooling medium flow path, in place of the separator 600 in accordance with the above embodiment. Such examples are described as a third modification and a fourth modification.

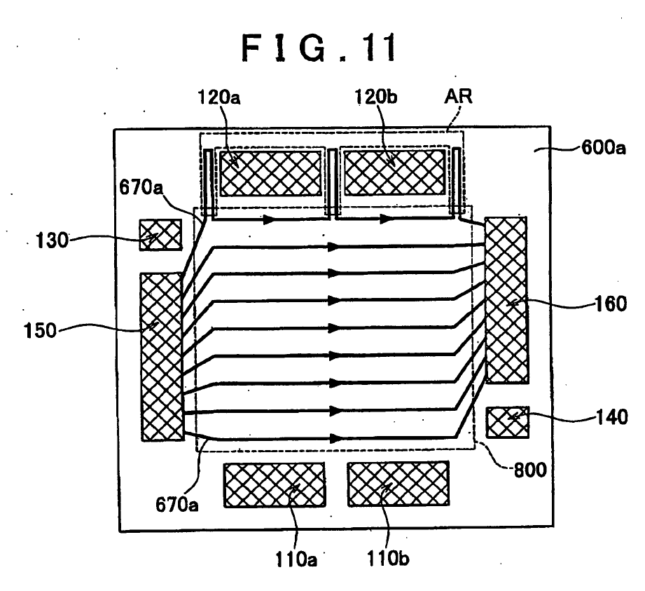

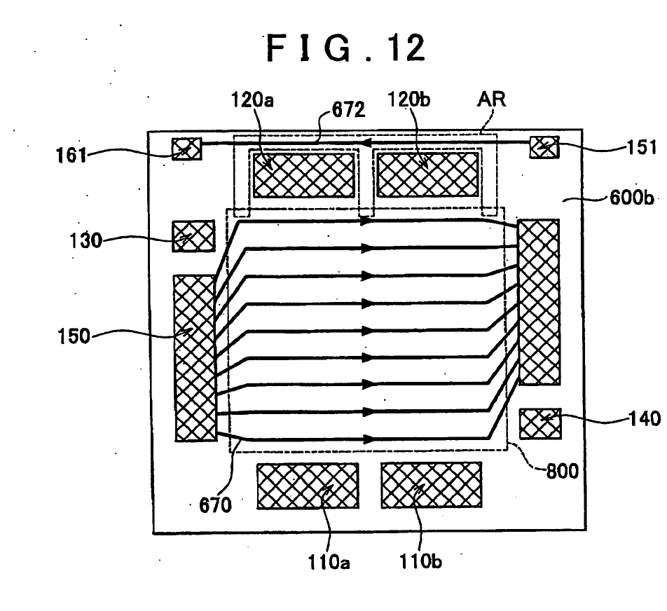

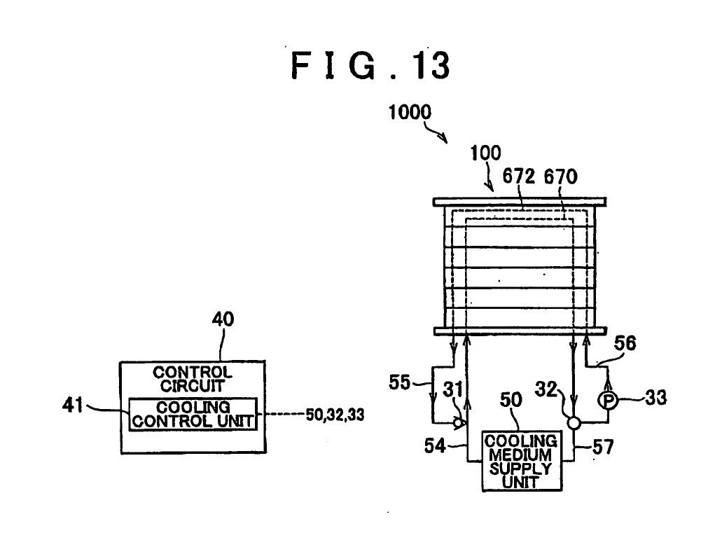

The third modification is described with reference to FIG. 11. FIG. 11 shows a separator in accordance with the third modification. In FIG. 11, to avoid complexity of the drawing, cooling medium flow paths formed inside the separator are indicated by the thick arrows. In practice, slits such as the cooling medium flow path forming parts 550 shown in FIG. 6C are formed in the intermediate plate along the paths indicated by the thick lines to fabricate the separator in accordance with this modification. The same applies to FIGS. 12 and 13 as described below.

As shown in FIG. 11, in the separator 600a in accordance with the third modification, one of a plurality of cooling medium flow paths 670a is disposed to pass not only through the power generation region overlapping the power generation part 800 but also through a region that does not overlap the power generation part 800. Specifically, a portion of the uppermost flow path in FIG. 11, of the plurality of cooling medium flow paths 670a, is disposed along the left side of the oxidant gas discharge manifold 120a in FIG. 11. Another part of that flow path is disposed to pass between the oxidant gas discharge manifolds 120a and 120b. Still another part of that flow path is disposed along the right side of the oxidant gas discharge manifold 120b in FIG. 11. The parts of the uppermost cooling medium flow path disposed on the outer side of the power generation part 800 overlap the heat conduction member 900 in the stacking direction (FIG. 11).

The configuration of the rest of the fuel cell in accordance with the third modification is the same as that of the fuel cell 100 in accordance with the above embodiment, and therefore is not described here.

According to the third modification, the cooling medium flows also around the oxidant gas discharge manifolds 120a and 120b, which are on the outer side of the power generation part 800. The cooling medium cools the power generation part in the region overlapping the power generation part. Meanwhile, the cooling medium warms in the region around the oxidant gas discharge manifolds 120a and 120b. As a result, the difference in the temperature between the part overlapping the power generation part in the stacking direction and the part inside and around the oxidant gas discharge manifolds 120a and 120b is further effectively reduced.

In addition, because the parts of the uppermost cooling medium flow path disposed on the outer side of the power generation part 800 overlap the heat conduction member 900 in the stacking direction, the heat of the power generation part 800 is conducted to the heat conduction member 900 via the cooling medium. As a result, the difference in the temperature may be further effectively reduced between the part overlapping the power generation part in the stacking direction and the part inside and around the oxidant gas discharge manifolds 120a and 120b.

The fourth modification is described with reference to FIGS. 12 and 13. FIG. 12 shows a separator in accordance with the fourth modification. The fuel cell in accordance with the fourth modification further includes a sub-cooling medium supply manifold 151 and a sub-cooling medium discharge manifold 161, in addition to the cooling medium supply manifold 150 and the cooling medium discharge manifold 160 that are the same as those in the above embodiment. The sub-cooling medium supply manifold 151 and the sub-cooling medium discharge manifold 161 are formed on one side and the other side, respectively, of the region where the oxidant gas discharge manifolds 120a and 120b are formed. The sub-cooling medium supply manifold 151 and the sub-cooling medium discharge manifold 161 are each formed as a through hole penetrating the separator 600b (FIG. 12) and the membrane electrode assembly (not shown), in the same way as the other manifolds.

In a separator 600b in accordance with the fourth modification, a sub-cooling medium flow path 672 for communication between the sub-cooling medium supply manifold 151 and the sub-cooling medium discharge manifold 161 is formed in the separator 600b, in addition to the cooling medium flow paths 670 that are the same as those in the preceding embodiment. As shown in FIG. 12, the sub-cooling medium flow path 672 passes through the side of the oxidant gas discharge manifolds 120a and 120b opposite to the power generation part 800. The sub-cooling medium flow path 672 also overlaps the heat conduction member 900 in the stacking direction. The coolant absorbs heat while flowing from the cooling medium supply manifold 150 to the cooling medium discharge manifold 160 and releases heat while flowing from the sub-cooling medium supply manifold 151 to the sub-cooling medium discharge manifold 161.

FIG. 13 is a diagram showing the schematic configuration of a fuel cell system including the fuel cell in accordance with the fourth modification. In FIG. 13, only the supply/discharge system for the cooling medium, which is essential in describing this modification, is shown, and other parts, for example the supply/discharge systems for the reaction gases, are not shown.

The fuel cell system 1000 in accordance with the fourth modification includes, in the supply/discharge system for the cooling medium, a cooling medium supply section 50, a cooling medium supply pipe 54, and a cooling medium discharge pipe 57 as in a typical fuel cell system. The cooling medium supply pipe 54 connects the cooling medium supply section 50 and the cooling medium supply manifold 150 of the fuel cell 100. The cooling medium discharge pipe 57 connects the cooling medium discharge manifold 160 of the fuel cell 100 and the cooling medium supply section 50. The cooling medium supply section 50 may be a known device such as a cooling medium tank, a cooling medium pump, and a radiator to circulate the cooling medium inside the fuel cell 100.

The fuel cell system 1000 in accordance with the fourth modification further includes a sub-cooling medium supply pipe 56 and a sub-cooling medium discharge pipe 55. One end of the sub-cooling medium supply pipe 56 is connected to the cooling medium discharge pipe 57 via a branch valve 32. The other end of the sub-cooling medium supply pipe 56 is connected to the sub-cooling medium supply manifold 151. A bypass pump 33 is disposed on the sub-cooling medium supply pipe 56. One end of the sub-cooling medium discharge pipe 55 is connected to the cooling medium supply pipe 54 via a check valve 31. The other end of the sub-cooling medium discharge pipe 55 is connected to the sub-cooling medium discharge manifold 161.

The fuel cell system 1000 further includes a control circuit 40 for controlling the entire system. The control circuit 40 is a known computer having a CPU, a ROM, and a RAM, and includes a cooling control section 41 as one of its control functions.

During operation of the fuel cell, the cooling control section 41 controls the flow of the cooling medium in the sub-cooling medium flow path 672 independently of the flow of the cooling medium in the cooling medium flow paths 670. For example, in this modification, the cooling control section 41 controls the cooling medium supply section SO, the branch valve 32, and the bypass pump 33 to switch between a first operation mode, in which the cooling medium is circulated only through the cooling medium supply manifold 150 and the cooling medium discharge manifold 160, and a second operation mode, in which the cooling medium is circulated through the sub-cooling medium supply manifold 151 and the sub-cooling medium discharge manifold 161 in addition to the cooling medium supply manifold 150 and the cooling medium discharge manifold 160. Specifically, in the first operation mode, the cooling control section 41 stops the bypass pump 33 and controls the branch valve 32 so that the cooling medium discharge pipe 57 is not communicated with the sub-cooling medium supply pipe 56. As a result, in the first operation mode, the cooling medium flows through the cooling medium flow paths 670 in each separator 600b (FIG. 12) of the fuel cell 100 but not through the sub-cooling medium flow path 672. In the second operation mode, the cooling control section 41 drives the bypass pump 33 and controls the branch valve 32 to communicate the cooling medium discharge pipe 57 and the sub-cooling medium supply pipe 56. As a result, in the second operation mode, the cooling medium flows through both the cooling medium flow paths 670 and the sub-cooling medium flow path 672 in each separator 600b (FIG. 12).

In the second operation mode, the cooling medium having flowed through the cooling medium flow paths 670 and been discharged to the cooling medium discharge pipe 57 is bypassed through the sub-cooling medium supply pipe 56 and the sub-cooling medium supply manifold 151 to be supplied to the sub-cooling medium flow path 672. Consequently, the cooling medium flowing through the cooling medium flow paths 670 cools the power generation part, and the cooling medium flowing through the sub-cooling medium flow path warms the area around the oxidant gas discharge manifolds 120a and 120b. As a result, the difference in the temperature in the second operation mode is reduced, as in the third modification described above, between the part overlapping the power generation part in the stacking direction and the part inside and around the oxidant gas discharge manifolds 120a and 120b.

The cooling control section 41 switches between the first operation mode and the second operation mode according to predetermined operating conditions. For example, the second operation mode is selected when the temperature difference between the part overlapping the power generation part in the stacking direction and the part inside and around the oxidant gas discharge manifolds 120a and 120b is forecast to increase, and the first operation mode is selected otherwise. In a specific example, the second operation mode is selected when the outside air temperature measured using a temperature sensor (not shown) is below a predetermined value (for example, below freezing), and the first operation mode is selected when it is above the predetermined value.

According to the fourth modification described above, the difference in the temperature between the part overlapping the power generation part in the stacking direction and the part inside and around the oxidant gas discharge manifolds 120a and 120b is reduced. Therefore, the functions and effects that are the same as those of the third modification can be realized. Further, according to the fourth modification, the cooling medium flows through the sub-cooling medium flow path 672 only when necessary according to the operating conditions. Therefore, it is possible to reduce the amount of energy (for example, battery power) required to operate the supply/discharge system for the cooling medium compared to the case where the cooling medium always flows through the sub-cooling medium flow path 672.

In the third modification and the fourth modification described above, the cooling medium may just flow around the oxidant gas discharge manifolds 120a and 120b, with the heat conduction members not provided. Even in such a case, the difference in the temperature between the part overlapping the power generation part in the stacking direction and the part inside and around the oxidant gas discharge manifolds 120a and 120b is reduced.

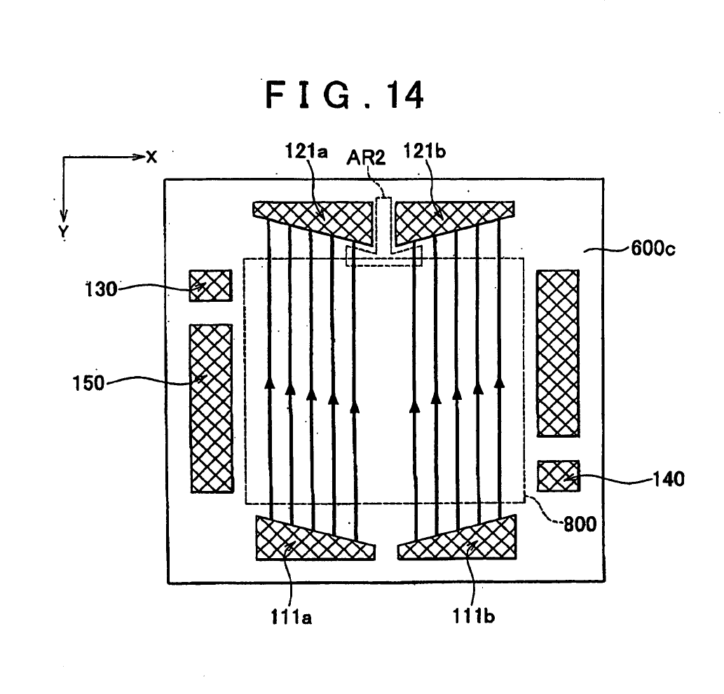

A fifth modification is described with reference to FIG. 14. The fuel cell in accordance with the fifth modification is formed with oxidant gas discharge manifolds 121a and 121b having a shape different from that of the oxidant gas discharge manifolds 120a and 120b in the above embodiment. The fuel cell in accordance with this modification is fabricated on the assumption that it is operated with the oxidant gas discharge manifolds 121a and 121b positioned opposite to the direction of gravity and the oxidant gas supply manifolds 111a and 111b positioned in the direction of gravity (with the positive direction of the Y-axis in FIG. 14 indicating the direction of gravity). As can be seen from the through holes (FIG. 14) forming the oxidant gas discharge manifolds 121a and 121b in a separator 600c in accordance with this modification, the oxidant gas discharge manifolds 121a and 121b have such a cross sectional shape that the side thereof near the power generation part 800 is not perpendicular to, but inclined at a predetermined angle with respect to, the direction of gravity when the fuel cell is in operation.

Although not shown, the non-power generation part of the membrane electrode assembly is also formed with through holes of the same shape for forming the oxidant gas discharge manifolds 121a and 121b. This allows water condensed inside the oxidant gas discharge manifold 121a to collect, due to gravity, at a portion of the oxidant gas discharge manifold 121a on the side of the positive direction of the X-axis in FIG. 14. This also allows water condensed inside the oxidant gas discharge manifold 121b to collect, due to gravity, at a portion of the oxidant gas discharge manifold 121b on the side of the negative direction of the X-axis in FIG. 14.

Further, in this modification, the heat conduction member is disposed along the portion of the oxidant gas discharge manifolds 121a and 121b where condensed water is collected, as can be seen from the shape of the region AR2 that is in contact with the heat conduction member indicated in FIG. 14. Consequently, in this modification, only the portion of the oxidant gas discharge manifolds 121a and 121b where water is collected is warmed to reduce the difference in the temperature between that portion and the power generation part. As a result, condensation of water in the oxidant gas discharge manifolds 121a and 121b is efficiently reduced using a smaller heat conduction member.

As shown in FIG. 14, sides of the oxidant gas supply manifolds 111a and 111b of the fuel cell towards the power generation part 800 (i.e., the sides thereof in the negative direction of the Y-axis in FIG. 14) according to this modification are inclined to be parallel to the inclined sides of the oxidant gas discharge manifolds 121a and 121b that face the oxidant gas supply manifolds 111a and 111b with interposing the power generation part 800. This is for the purpose of making the lengths of the flow paths for the oxidant gas from the oxidant gas supply manifolds 111a and 111b to the oxidant gas discharge manifolds 121a and 121b equal to each other at each part of the power generation part 800, as indicated by the thick arrows in FIG. 14. This equalizes the pressure loss of the oxidant gas in each flow path, and facilitates uniform distribution of the supply of the oxidant gas to the power generation part 800.

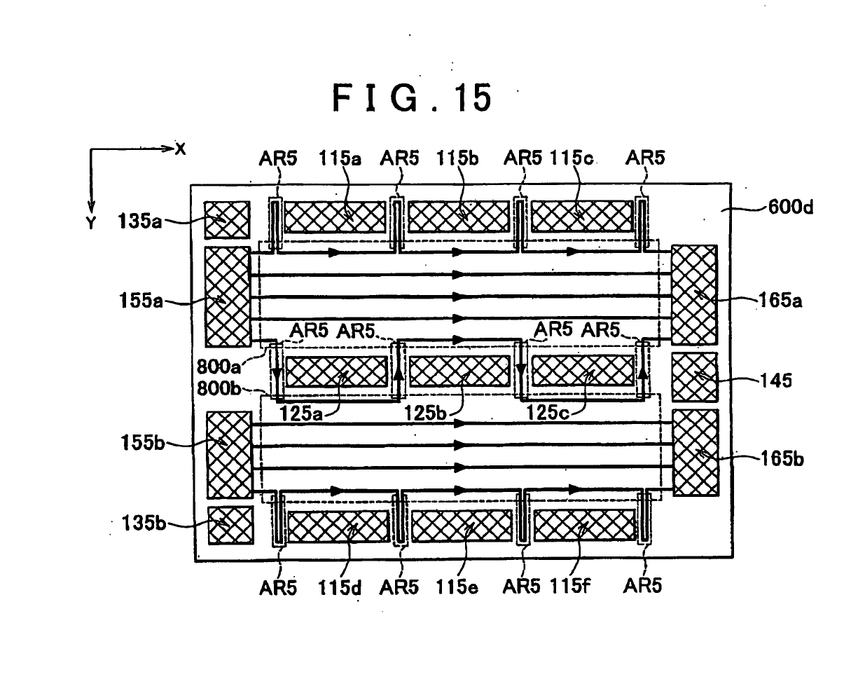

The arrangement of the respective manifolds, of the cooling medium flow paths inside the separator, and of the heat conduction members in the embodiment and the modifications described above are examples only, and may be modified in various ways. An arrangement different from those in the embodiment and the modifications described above is described as a sixth modification with reference to FIG. 15. FIG. 15 shows a separator in accordance with the sixth modification. In FIG. 15, in order to indicate the arrangement of the heat conduction members in accordance with the sixth modification, the regions AR5 are indicated by the dashed line that each contact a heat conduction member when the separator in accordance with the sixth modification is assembled into a fuel cell. Also in FIG. 15, in order to further indicate the configuration of the membrane electrode assembly in accordance with the sixth modification, the regions are indicated by the dashed line that respectively face two power generation parts 800a and 800b of the membrane electrode assembly when the separator in accordance with the sixth modification is assembled into a fuel cell.

Although not shown, the membrane electrode assembly in accordance with the sixth modification has generally the same size and shape as those of a separator 600d shown in FIG. 15, and includes two power generation parts 800a and 800b respectively corresponding to the regions indicated by the dashed line in FIG. 15, and a non-power generation part having through holes for forming the manifolds in the separator 600d shown in FIG. 15.

As can be seen from the through holes (FIG. 15) for forming the respective manifolds in the separator 600d, the fuel cell in accordance with the sixth modification includes three oxidant gas discharge manifolds 125a to 125c between the power generation parts 800a and 800b. The fuel cell in accordance with the sixth modification also includes a total of six oxidant gas supply manifolds, three (115a to 115c) opposite the three oxidant gas discharge manifolds 125a to 125c across the power generation part 800a and three (115d to 115f) opposite the oxidant gas discharge manifolds 125a to 125c across the power generation part 800b. The oxidant gas flows from the oxidant gas supply manifolds 115a to 115c to the oxidant gas discharge manifolds 125a to 125c, and from the oxidant gas supply manifolds 115d to 115f to the oxidant gas discharge manifolds 125a to 125c.

The fuel cell in accordance with the sixth modification includes heat conduction members between the cathode side of the separator 600d and the cathode side of the non-power generation part of the membrane electrode assembly, as in the above embodiment. As indicated by the dashed line (AR5) in FIG. 15, the heat conduction members are positioned in the vicinity of the three oxidant gas discharge manifolds 125a to 125c and the six oxidant gas supply manifolds 115a to 115f as seen in the stacking direction. Specifically, the heat conduction members arc arranged along both sides of the respective manifolds mentioned above in the X-axis direction in FIG. 15.

As shown in FIG. 15, the fuel cell in accordance with the sixth modification further includes two fuel gas supply manifolds 135a and 135b and one fuel gas discharge manifold 145. The fuel gas flows from the fuel gas supply manifold 135a to the fuel gas discharge manifold 145, and from the fuel gas supply manifold 135b to the fuel gas discharge manifold 145.

As shown in FIG. 15, the fuel cell in accordance with the sixth modification further includes two cooling medium supply manifolds 155a and 155b and two cooling medium discharge manifolds 165a and 165b. As indicated by the thick arrows in FIG. 15, a plurality of cooling medium flow paths are formed inside the separator 600d of the fuel cell in accordance with the sixth modification. One end of each cooling medium flow path is communicated with the cooling medium supply manifold 155a or 155b. The other end of each cooling medium flow path is communicated with the cooling medium discharge manifold 165a or 165b. The plurality of cooling medium flow paths are disposed over the entire power generation parts 800a and 800b. Some of the cooling medium flow paths is disposed around the three oxidant gas discharge manifolds 125a to 125c and the six oxidant gas supply manifolds 115a to 115f outside the power generation parts 800a and 800b. Some of the cooling medium flow paths that is disposed around the manifolds overlaps the heat conduction members in the stacking direction. For example, as shown in FIG. 15, one of the cooling medium flow paths is disposed to weave between the three oxidant gas discharge manifolds 125a to 125c.

According to the thus configured fuel cell, the difference in the temperature between the part overlapping the power generation part in the stacking direction and the part inside and around the oxidant gas supply/discharge manifolds may be reduced due to the arrangement of the heat conduction members and the cooling medium flow paths. As a result, problems due to such a difference in the temperature are reduced as in the above embodiment.

Further according to the fuel cell in accordance with this modification, the three oxidant gas discharge manifolds 125a to 125c, through which the oxidant gas containing much water flows, are disposed generally in the middle, or between the two power generation parts, as seen in the stacking direction. Consequently, the inside of the three oxidant gas discharge manifolds 125a to 125c is not easily influenced by the outside air temperature. Thus, a difference in the temperature is not likely to occur between the inside of the three oxidant gas discharge manifolds 125a to 125c and the part overlapping the power generation part in the stacking direction, even at low outside air temperatures. As a result, problems due to such temperature differentials are further reduced.

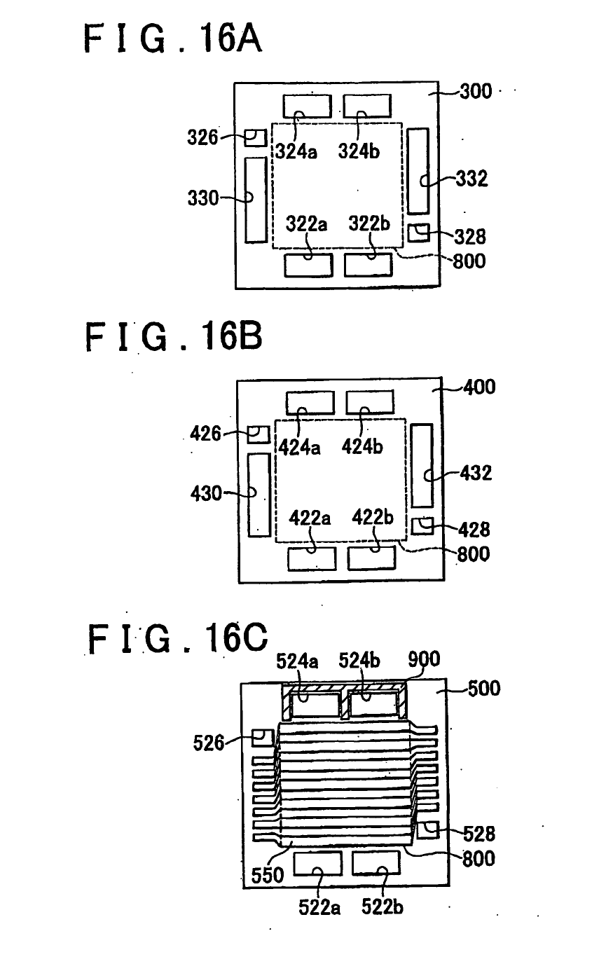

Although the heat conduction member 900 is disposed between separators 600 disposed adjacent to each other with the membrane electrode assembly 200 interposed between the separators in the above embodiment, the present invention is not limited thereto. For example, the heat conduction member 900 may be disposed inside the separator 600. Such an example is described as a seventh modification with reference to FIG. 16. FIG. 16 is a diagram showing respective plates composing a separator in accordance with the seventh modification.

The separator in accordance with the seventh modification differs from the embodiment shown in FIG. 6 in that, as indicated by the hatched area in FIG. 16C, the intermediate plate 500 includes a heat conduction member 900. Such an intermediate plate 500 may be fabricated by, for example, forming a through hole corresponding to the heat conduction member 900 in the intermediate plate 500, and fitting the heat conduction member 900 in the through hole. The configuration of the rest of the separator in accordance with the seventh modification is the same as that of the separator shown in FIG. 6. Therefore, like reference numerals are used in FIG. 16 to designate like parts in FIG. 6 in order to omit their descriptions. Also according to this modification, the difference in the temperature between the power generation part 800 and the non-power generation part 700 is reduced.

Although the materials of the respective components of the power generation part 800 and the separators 600 are specified in the above embodiment, these materials are not limitative, and various suitable materials may be used. For example, the anode-side porous body 840 and the cathode-side porous body 850 may be made of a material other than a metal porous material such as a carbon porous material. Also, the separator 600 may be made of a material other than metal such as carbon. The heat conduction member 900 may be made of a material having a heat conductivity higher than that of the material of the separator 600.

Although the separator 600 is composed of three layers of metal plates laminated together and flat at the part corresponding to the power generation region in the above embodiment, the separator 600 may be configured in other ways. Specifically, the separator may be formed with a groove-like reaction gas flow path in the surface corresponding to the power generation region (such a separator may be fabricated of carbon, for example), or may be formed in the shape of a corrugated plate to function as a reaction gas flow path in the part corresponding to the power generation region (such a separator may be fabricated by pressing a metal plate, for example).

Moreover, although the above embodiment is provided with an anode-side porous body 840 and a cathode-side porous body 850, the present invention is not limited thereto. For example, an anode-side porous body and a cathode-side porous body may omitted if a separator formed with a reaction gas flow path or a separator formed in the shape of a corrugated plate to function as a reaction gas flow path is used.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A fuel cell comprising:
a power generation part that includes an electrolyte membrane;
a non-power generation part that is disposed along an outer peripheral edge of the power generation part;
a separator that is alternately stacked with the power generation part, and is provided with a gas flow path, through which a reaction gas flows to the power generation part, the separator having a first region that overlaps the power generation part in the stacking direction and a second region that overlaps the non-power generation part in the stacking direction; and
a heat conduction member that overlaps at least the second region of the separator in the stacking direction and that has a heat conductivity higher than that of the separator.

2. The fuel cell according to claim 1, wherein:
the reaction gas includes oxidant gas and fuel gas;
the separator is provided with a first separator through which the oxidant gas flows and a second separator through which the fuel gas flows; and
the heat conduction member is disposed between the first separator and the second separator, which in turn are disposed adjacent to each other with interposing the power generation part between the first separator and the second separator.

3. The fuel cell according to claim 1, wherein the heat conduction member is disposed inside the separator.

4. The fuel cell according to claim 1, wherein the heat conduction member is fitted in a recess that is formed in the separator.

5. The fuel cell according to any one of claims 1 to 4, wherein a portion of the heat conduction member overlaps the first region of the separator in the stacking direction.

6. The fuel cell according to any one of claims 1 to 5, wherein:
the separator has a manifold hole in the second region through which the reaction gas flows; and
the heat conduction member is disposed around the manifold hole.

7. The fuel cell according to any one of claims 1 to 6, wherein:
the separator has a cooling medium flow path through which a cooling medium for cooling the power generation part flows; and
the heat conduction member overlaps the cooling medium flow path of the separator in the stacking direction.

8. The fuel cell according to claim 7, wherein the cooling medium flow path passes through the second region.

9. The fuel cell according to any one of claims 2 to 8, wherein the heat conduction member is in contact with the first separator.

10. The fuel cell according to claim 6, wherein:
the manifold hole includes a supply manifold hole for supplying the reaction gas and a discharge manifold hole for discharging the reaction gas; and
the heat conduction member is disposed around the discharge manifold hole.

11. The fuel cell according to claim 10, wherein the heat conduction member is disposed around the supply manifold hole.

12. The fuel cell according to claim 10, wherein the heat conduction member is disposed around the discharge manifold hole except for the first region side of the discharge manifold hole.

13. The fuel cell according to any one of claims 10 to 12, wherein the discharge manifold hole is positioned opposite to the direction of gravity with respect to the first region of the separator when the fuel cell is in operation.

14. The fuel cell according to claim 13, wherein:
the discharge manifold hole has such a shape that water present in the discharge manifold hole collects at a portion of the discharge manifold hole due to gravity; and
the heat conduction member is disposed along the portion of the discharge manifold hole where the water collects.

15. The fuel cell according to claim 3, wherein:
the separator includes an anode plate, a cathode plate, and an intermediate plate disposed between the anode plate and the cathode plate; and
the heat conduction member is disposed in the intermediate plate.

16. The fuel cell according to any one of claims 1 to 15, wherein the heat conduction member contains copper.

17. The fuel cell according to any one of claims 1 to 16, wherein the heat conduction member has a heat conductivity of about 0.95 Cal·cm⁻¹·° C.⁻¹·second⁻¹.

18. A fuel cell comprising:
a power generation part that includes an electrolyte membrane;
a non-power generation part that is disposed along an outer peripheral edge of the power generation part; and
a separator that is alternately stacked with the power generation part, and is provided with a cooling medium flow path through which a cooling medium for cooling the power generation part flows, the separator having a first region that overlaps the power generation part in the stacking direction and a second region that overlaps the non-power generation part in the stacking direction,
wherein the cooling medium flow path passes through the first region and the second region.

19. The fuel cell according to claim 18, wherein:
the separator has a manifold hole that is formed to penetrate the second region in the stacking direction, and through which a reaction gas flows; and
the cooling medium flow path is disposed opposite to the first region with respect to the manifold hole.

20. The fuel cell according to claim 19, wherein:
the separator has a plurality of the manifold holes; and
a portion of the cooling medium flow path passes between the plurality of manifold holes.

21. The fuel cell according to any one of claims 18 to 20, wherein:
the cooling medium flow path includes a first flow path that passes through the first region and a second flow path that passes through the second region; and
a flow of the cooling medium in the first flow path and the flow of the cooling medium in the second flow path are independently controlled based on operating conditions.

22. The fuel cell according to claim 21, further comprising a heat conduction member that is disposed to overlap the second region of the separator in the stacking direction and that has a heat conductivity higher than that of the separator,
wherein the heat conduction member is disposed in the separator to overlap the second flow path of the cooling medium flow path.
